(19) United States
(12) Patent Application Publication
(10) Pub. No.: US 2009/0061307 A1
(43) Pub. Date: Mar. 5, 2009

(54) Can type lithium secondary battery

(76) Inventor: Hwail Uh, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/219,220

(22) Filed: Jul. 17, 2008

(30) Foreign Application Priority Data
Sep. 3, 2007 (KR) 10-2007-0089090

(51) Int. Cl. H01M 2/30; H01M 2/02

(52) U.S. Cl. 429/178; 429/185

(57) ABSTRACT

A can type lithium secondary battery preventing a cap assembly having a terminal plate from being deformed due to a spinning pressure introduced by an insertion of an electrode terminal by forming a reinforcing part on a terminal plate includes an electrode assembly having a first electrode plate, a second electrode plate and a separator formed between the first and second electrode plates, a can receiving the electrode assembly and an electrolyte, and a cap assembly including a cap plate, an insulation plate, a terminal plate with a reinforcing part for preventing the deformation of the terminal plate, an electrode terminal, and a gasket coupled to an upper end opening of the can.

The can type lithium secondary battery may include protrusions formed on insulation plate and terminal plate respectively, and grooves formed in the cap plate, insulation plate and terminal plate respectively for receiving the corresponding protrusions, and the grooves may be formed in the cap plate, insulation plate and terminal plate respectively.

### CLAIM OF PRIORITY

This application makes reference to, incorporates the same herein, and claims all benefits accruing under 35 U.S.C. §119 from an application earlier filed in the Korean Intellectual Property Office on Sep. 3, 2007 and there duly assigned Serial No. 10-2007-0089090.

### BACKGROUND

1. Field of the Invention

The present invention relates to a can type lithium secondary battery, and more particularly, to a can type lithium secondary battery that includes a reinforcing part formed on a terminal plate to prevent a cap assembly including the terminal plate from being deformed by the spinning pressure of an electrode terminal.

2. Description of the Related Art

Recently, portable electronic devices such as cellular phones, notebook computers, camcorders, and other portable electronic devices, have been made compact and light weight. These portable electronic devices have a built-in battery pack so as to operate in places where a separate power supply can not be provided. The built-in battery pack includes at least one battery to output a constant voltage so as to enable the portable electronic devices to be driven for a constant time period.

The battery pack uses a chargeable/dischargeable secondary battery because the secondary battery requires low cost. The secondary batteries typically include a nickel-cadmium (Ni—Cd) battery, a nickel-hydride (Ni-MH) battery, a lithium (Li) battery, a lithium-ion (Li-ion) battery and a lithium secondary battery. The usage of lithium secondary batteries has been rapidly extended because an operation voltage (i.e., 3.6V) of the lithium secondary battery is three times more than that of nickel-cadmium and nickel-hydrogen battery mainly used as a power supply of the portable electronic device, and has a lighter energy density per weight.

The lithium secondary battery mainly uses lithium oxide as cathode active materials, and uses carbon materials as anode active materials. Generally, the lithium secondary battery is classified into a liquid electrolyte battery and a high polymer electrode battery in accordance to the of electrolyte. The liquid electrolyte battery is referred to as a lithium ion battery, and the high polymer battery is referred to as a lithium polymer battery.

Generally, the lithium ion secondary battery includes an electrode assembly wound by a cathode electrode plate coated by the cathode active material, an anode electrode plate coated by the anode active material, and a separator located between the cathode plate and the anode plate so as to prevent an electrical short circuit, and move lithium ions, a case receiving the electrode assembly, and an electrolyte injected into the case so as to move the lithium ions.

A can type lithium secondary battery for lithium secondary batteries is currently formed by the following processes.

First, an electrode assembly is manufactured by stacking a cathode plate coated by the cathode active material and connected to a cathode tab, an anode plate coated by an anode active material and connected to an anode tab, and a separator located between the cathode plate and anode plate, and winding these three components.

Next, the electrode assembly is received in a battery case having a can shape. A cap assembly including a cap plate, an insulation plate, a terminal plate, a gasket, and an electrode terminal which is formed at an upper end of the case. The cap assembly and the case are assembled by welding, and an electrolyte is injected into the lithium secondary battery case through an inlet and the inlet is sealed after the injection.

Finally, a protection circuit module is attached to an upper end of the cap assembly and the protection circuit module is molded.

The can type lithium secondary battery forms a can assembly by creating terminal holes that can receive an electrode terminal in the cap plate, the insulation plate and the terminal plate respectively, and applies a spinning pressure to the electrode terminal so as to insert the electrode terminal into the terminal hole.

When the spinning pressure is given to the electrode terminal however, the terminal plate is deformed by the spinning pressure. The deformation of the terminal plate causes an adhesion force between the terminal plate, the insulation plate and the cap plate to be reduced. Therefore, resistance between the electrode plate and the terminal plate is increased. Consequently, the electrical character of the lithium secondary battery deteriorates.

### SUMMARY OF THE INVENTION

It is, therefore, an object of the present invention to provide an improved can type lithium secondary battery to overcome the disadvantages stated above.

It is another object of the present invention to provide a can type lithium secondary battery that can prevent a cap assembly including a terminal plate from being deformed during application of spinning force of an electrode terminal by forming a reinforcing part on a terminal plate.

Another aspect of the invention will be set forth in part in the description which follows and in part will become apparent to those having ordinary skill in the art upon examination of the following or may be learned from practice of the invention.

The present invention is provided a can type lithium secondary battery, which includes, an electrode assembly including a first electrode plate, a second electrode plate and a separator, a can receiving the electrode assembly and an electrolyte, and a cap assembly including a cap plate, an insulation plate, a terminal plate, an electrode terminal, and a gasket so as to be coupled to an upper end opening of the can, and seal the can, and the terminal plate includes a reinforcing part formed to surround a peripheral part of a terminal hole where the electrode terminal is inserted.

The reinforcing part is formed on any one of an upper surface and a lower surface of the terminal plate.

A periphery of a horizontal cross-section of the reinforcing part may be formed in one of a circle shape and a square shape.

The reinforcing part may be formed with a thickness of between approximately 0.1 mm to 0.4 mm.

The electrode terminal may be formed on a lower part of the terminal plate, and include a spinning part including an edge part whose side end is formed to protrude. The reinforcing part may be formed to be wider than the edge part.

The insulation plate may include a first protrusion protruding toward the cap plate as much as a thickness corresponding to thickness of the reinforcing part. Here, the cap plate may include a first groove for receiving the first protrusion.

The insulation plate may include a groove for receiving the reinforcing part.

Further, the reinforcing part may be constructed with a first reinforcing part and a second reinforcing part respectively formed on the upper and lower surfaces of the terminal plate. Here, the first reinforcing part and the second reinforcing part may be respectively formed with thickness of between approximately 0.1 mm to 0.2 mm.

The reinforcing part may be integrated with the terminal plate.

The insulation plate may further include a first protrusion for preventing a rotation when the electrode terminal is inserted. Here, the terminal plate is received in the first protrusion, and may further include a second protrusion able to preventing a rotation, when the electrode terminal is inserted. Further, the cap plate may be constructed with a second groove able to receive the first protrusion and prevent a rotation.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a exploded perspective view illustrating a can type secondary battery constructed according to one exemplary embodiment of the present invention;

FIG. 2 is a plan view illustrating a can type secondary battery constructed according to one exemplary embodiment of the present invention;

FIG. 3 is a vertical cross-section view taken along sectional line I-I′ in FIG. 2

FIG. 4 is a partial vertical cross-section view illustrating a cap assembly constructed according to one exemplary embodiment of the present invention;

FIG. 5a is a plan view illustrating an insulation plate constructed according to one exemplary embodiment of the present invention;

FIG. 5b is a plan view illustrating an insulation plate constructed according to another embodiment of the present invention;

FIG. 6 is a partial vertical cross-section view illustrating a cap assembly constructed according to another exemplary embodiment of the present invention;

FIG. 7 is a partial vertical cross-section view illustrating a cap assembly constructed according to still another exemplary embodiment of the present invention; and

FIG. 8 is a partial vertical cross-section view illustrating a cap assembly constructed according to yet still another exemplary embodiment of the present invention.

### DETAILED DESCRIPTION OF EXEMPLARY EMBODIMENTS

Hereinafter, preferred embodiments of the present invention will be described in detail with reference to the accompanying drawing. The aspects and features of the present invention and methods for achieving the aspects and features will be apparent by referring to the embodiments to be described in details with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used to present the same elements across various figures.

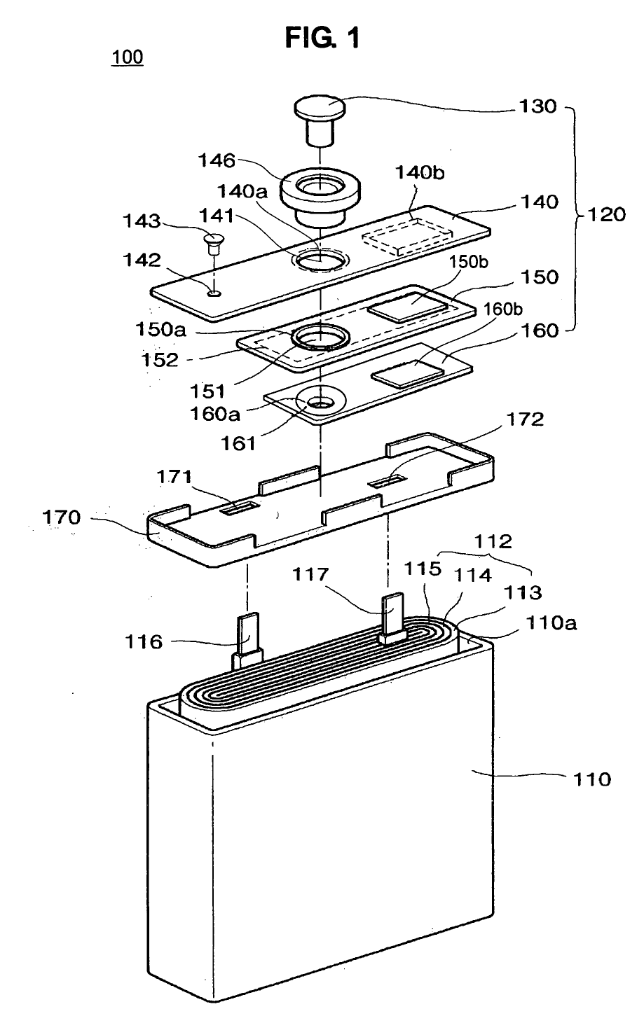

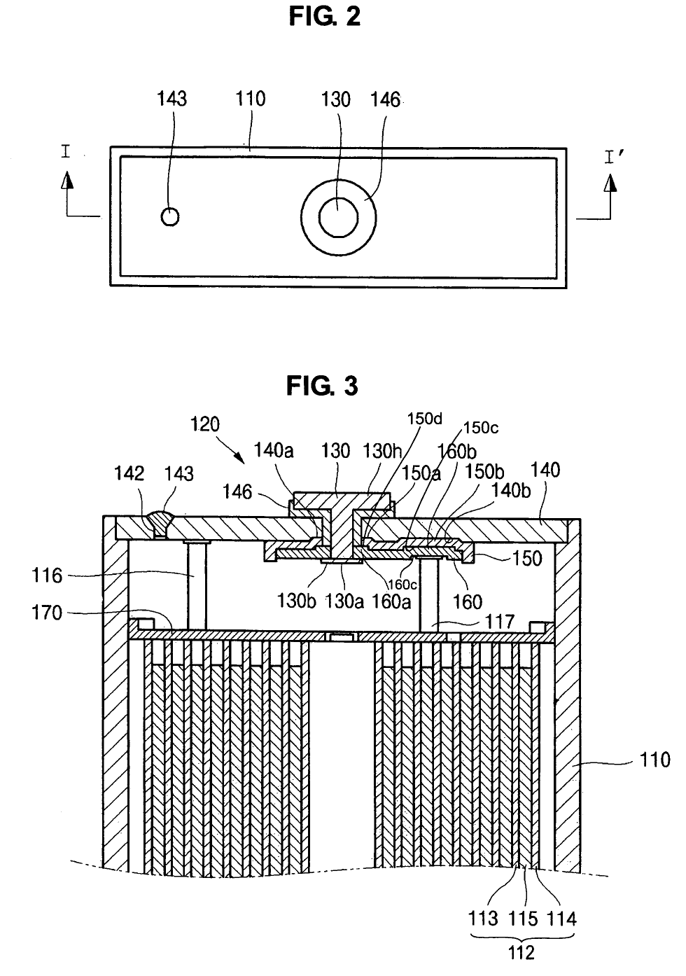

Turning now to FIGS. 1 to 5b, a can type lithium secondary battery 100 includes a can 110, a electrode assembly 112 received inside of can 110, and a cap assembly 120 sealing an upper end opening 110a of can 110. Can type lithium secondary battery 100 may further include an insulation case 170 between electrode assembly 112 and cap assembly 120.

Can 110 may be formed by metal materials and rough in a box shape. Can 110 may be formed by aluminum or aluminum alloy that is light and ductile, but not limited thereto. Can 110 includes upper end opening 110a which has one open surface facing insulation case 170, and electrode assembly 112 received by can 110 through upper end opening 110a. Further, can 110 may receive an electrolyte injected through an electrolyte inlet 142 formed in cap assembly 120.

Electrode assembly 112 includes a first electrode plate 113, a second electrode plate 115, and a separator 114. Electrode assembly 112 interposes separator 114 between first electrode plate 113 and second electrode plate 115, and these three components may be wound in a jelly roll shape. One end of a first electrode tab 116 is welded into first electrode plate 113, and the other end of first electrode tab 116 is protruded toward upper end opening 110a of can 110. Further, one end of a second electrode tab 117 is welded into second electrode plate 115, and the other end of second electrode tab 117 may be protruded toward upper end opening 110a of can 110. Here, first electrode plate 113 may be formed as an anode plate, and second plate 115 may be formed by a cathode plate. However, polarities of first electrode plate 113 and second electrode plate 115 are not limited in the present invention, and may be reversely formed by the character of the lithium secondary battery.

Cap assembly 120 includes an electrode terminal 130, a cap plate 140, an insulation plate 150, and a terminal plate 160. Cap assembly 120 seals can 110 by coupling cap plate 140 to the upper end of can 110.

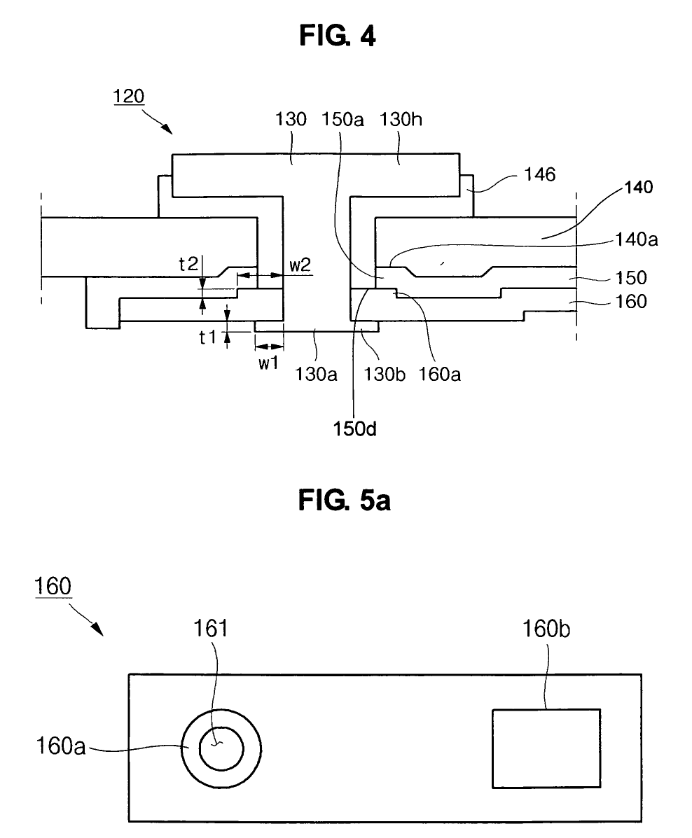

Electrode terminal 130 is inserted to terminal holes 141, 151, 161 formed in cap plate 140, insulation plate 150 and terminal plate 160 respectively so as to be electrically coupled to second electrode tab 117 of electrode assembly 112 through terminal plate 160. Here, terminal holes 141, 151, 161 are through holes. Here, electrode terminal 130 may be electrically insulated from cap plate 140 by a gasket 146. Gasket 146 will be further explained below. Electrode terminal 130 may be formed in one of a circular shape or a square shape, but is not limited thereto. Electrode terminal 130 may be assembled by being inserted into terminal through holes 141, 151, and 161 by a spinning method giving a predetermined pressure applied on the lower portion of electrode terminal 130 (as shown in FIGS. 3, 4). A head 130h refers to the upper portion of electrode terminal 130 and faces to the exterior of the battery. The predetermined pressure used by the spinning method will be presented as “a spinning pressure”. Head 130h of electrode terminal 130 is formed after electrode terminal 130 is inserted, or, head 130h is formed by a punch process. A spinning part 130a is formed at the lower portion of electrode terminal 130 and is oppositely to head 130h. Spinning part 130a faces to electrode assembly 112. Spinning part 130a is formed at the lower surface of terminal plate 160 by the spinning pressure applied on the lower portion of electrode terminal 130 during electrode terminal 130 is inserted into terminal through holes 141, 151, and 161. In this case, spinning part 130a has an edge 130b protruding towards away from the central axis of the electrical terminal. Thickness t1(as shown in FIG. 4) of spinning part 130a and width w1 (as shown in FIG.4) of edge 130b may be varied by the spinning pressure that is determined when electrode terminal 130 is inserted but not limited thereto. Cap plate 140 may be formed by a metal plate having a size corresponding to the upper end of can 110, and seal the upper part of can 110 by welding. First terminal hole 141 that can receive electrode terminal 130 and a gasket 146 is formed at the center of cap plate 140, and an electrolyte inlet 142 is formed on one side of cap plate 140. Further, cap plate 140 may include a first groove 140a that is formed to the periphery of first terminal hole 141. Cap plate 140 may include a second groove 140b for receiving a third protrusion 150b formed on insulation plate 150 to prevent a relative rotation between cap plate 140 and insulation plate 150 due to the spinning pressure. Here, first groove 140a and second groove 140b may be formed respectively so as to be pressurized from the lower surface of cap plate 140 towards the upper surface thereof. First groove 140a and second groove 140b may be formed by appropriate depth by considering the size of contacted area with insulation plate 150.

Third protrusion 150b is formed on the upper surface of insulation plate 150 and in the area where second terminal hole 151 is not located; second protrusion 160b is formed on the upper surface of terminal plate 160 and in the area where third terminal hole 161 is not located.

Electrode terminal 130 is inserted through first through terminal hole 141 of cap plate 140. A gasket 146 for insulating electrode terminal 130 from cap plate 140 maybe assembled in the inner of first terminal hole 141. Electrolyte inlet 142 is formed in a predetermined size on one side of cap plate 140. In electrolyte inlet 142, the electrolyte (not shown in figures) may be injected after cap assembly 120 is coupled to the upper end of can 110. Electrolyte inlet 142 may be sealed by a sealing unit. Here, electrolyte inlet 142 may be closed by a stopper 143. Stopper 143 may be formed in a plate shape so as to seal electrolyte inlet 142 by welding, but not limited thereto.

Gasket 146 is formed in a tube shape corresponding to the external shape of electrode terminal 130, and inserted into first terminal hole 141 of cap plate 140 with electrode terminal 130. Gasket 146 electrically insulates electrode terminal 130 and cap plate 140 because Gasket 146 is formed by insulation materials.

Insulation plate 150, similar to gasket 146, is formed by insulation materials, and insulation plate 150 is coupled to the lower surface of cap plate 140. Insulation plate 150 electrically insulates cap plate 140 from terminal plate 160. Insulation plate 150 may include a second terminal hole 151, a first protrusion 150a, a third protrusion 150b for preventing a relative rotation between insulation plate 150 and cap plate 140 due to the spinning pressure. Second terminal hole 151 maybe formed in a position corresponding to first terminal hole 141 of cap plate 140 when insulation plate 150 is coupled to cap plate 140. Second terminal hole 151 maybe formed in the same size as first terminal hole 141 of cap plate 140 for receiving electrode terminal 130. Additionally, second terminal hole 151 may receive electrode terminal 131 together with gasket 146. First protrusion 150a is formed to the periphery of second terminal hole 151. First protrusion 150a may be protruded toward cap plate 140 for a predetermined distance corresponding to the thickness of a reinforcing part 160a of terminal plate 160. Therefore, a fifth groove 150d is formed in the lower surface of insulation plate 150 to receive the reinforcing part 160a, and the depth of fifth groove 150d is corresponding to the thickness of reinforcing part 160a. Accordingly, first protrusion 150a may be formed so as to be pressurized from the lower surface of insulation plate 150 into upper surface thereof so as to enable a lower surface of insulation plate 150 to receive reinforcing part 160a of terminal plate 160. Here, first protrusion 150a may be received by first groove 140a formed on cap plate 140. Insulation plate 150 may further include third protrusion 150b, when electrode terminal 130 is inserted. Third protrusion 150b is formed to be protruded toward cap plate 140. Third protrusion 150b is formed to enable second groove 140b of cap plate 140 to receive the protruded upper surface of insulation plate 150, and enable the pressed lower surface to receive a second protrusion 160b of terminal plate 160.

Terminal plate 160 is formed by Nickel or a Nickel alloy, and coupled by electrically contacting the lower surface of insulation plate 150. Terminal plate 160 is electrically insulated from cap plate 140 by insulation plate 150, and electrically coupled to electrode terminal 130. Terminal plate 160 includes a third terminal hole 161, reinforcing part 160a, and second protrusion 160b. Third terminal hole 161 may be formed in position corresponding to second terminal hole 151 of insulation plate 150 when terminal plate 160 is coupled to insulation plate 150. Third terminal hole 161 is to receive electrode terminal 130, and may be smaller than second terminal hole 151 of insulation plate 150.

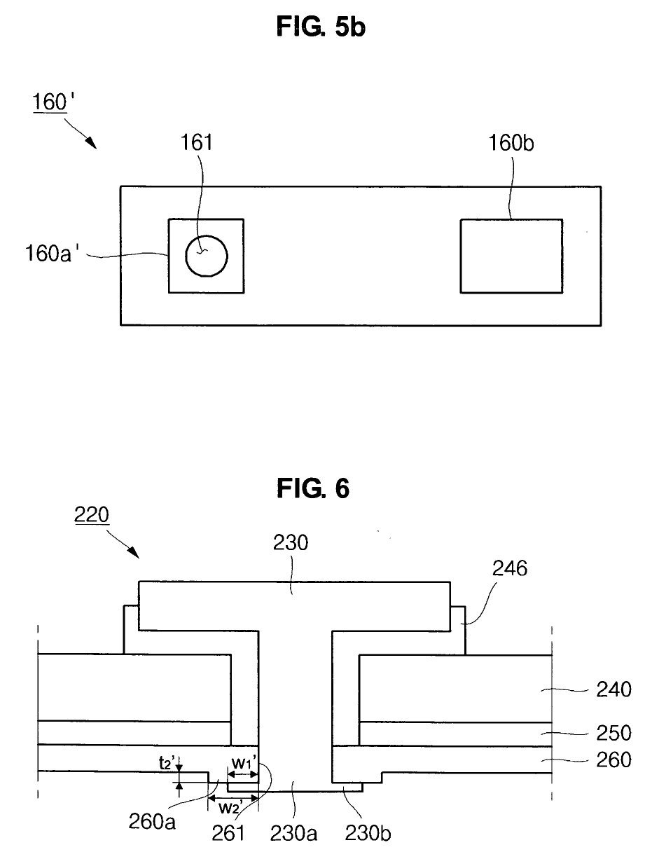

Reinforcing part 160a may be formed on the upper surface of terminal plate 160 so as to surround a periphery of third terminal hole 161. Here, reinforcing part 160a may be integrated with terminal plate 160. Referring to terminal plate 160 as shown in FIG. 5a, the periphery of reinforcing part 160a may be formed in a circular shape. Thickness t2 of reinforcing part 160a (as shown in FIG. 4) should be formed considering the spinning pressure and the shape of the can type lithium secondary battery. For example, reinforcing part 160a may be formed with thickness t2 of approximately 0.1˜0.4 mm. If the thickness t2 of reinforcing part 160a is below 0.1 mm, the deformation of terminal plate 160 due to the spinning pressure may not be sufficiently prevented. On the other hand, if thickness t2 of reinforcing part 160a is above 0.4 mm, it is not suitable to the recent light weighting trend of the can type lithium secondary battery. Further, width w2 of reinforcing part 160a may be formed to be wider than that of edge 130b (i.e. w1) formed by the spinning pressure within the size range of terminal plate 160. Accordingly, reinforcing part 160a is formed so as to stably support spinning part 130a and edge 130b of electrode terminal 130, thereby preventing terminal plate 160 from being deformed due to the spinning pressure. Thickness t2 and width w2 of reinforcing part 160a of the present invention, however, may be varied according to the structure of the lithium secondary battery.

The shape of reinforcing part 160a may be formed differently when terminal plate 160 is regarded as a plane. For example, as shown in FIG. 5b, the periphery of reinforcing part 160a′ in cap assembly 120 may be formed in a rectangular or a square shape.

Second protrusion 160b is formed in a size corresponding to the lower surface of third protrusion 150b, so as to be fixed to third protrusion 150b. Second protrusion 160b is fixed so as to prevent insulation plate 150 from relatively rotating about terminal plate 160 when electrode terminal 130 is inserted by the spinning process. Before electrode terminal 130 is inserted in to can 110 by the spinning process, the grooves and the protrusions of cap 40, insulation plate 150 and terminal plate 160 are formed.

Insulation case 170 may be formed so as to be coupled to the lower part of cap assembly 120. Insulation case 170 electrically insulates electrode assembly 112 from cap assembly 120. Insulation plate 150 may include a first electrode tab hole 171 and a second electrode tab hole 172. Accordingly, first electrode tab 116 is electrically coupled to cap plate 140 through first electrode tab hole 171. Further, second electrode tab 117 is electrically coupled to terminal plate 160 through second electrode tab hole 172.

Can type lithium secondary battery 100 includes reinforcing part 160a formed so as to surround the periphery of third terminal hole 161 of terminal plate 160 included in cap assembly 120. Electrode terminal 130, gasket 146, cap plate 140, insulation plate 150 and terminal plate 160 are coupled by being closely attached by the strong spinning pressure generated during electrode terminal 130 is inserted into third terminal hole 161. Reinforcing part 160a is formed on the periphery of third terminal hole 161 being under the spinning pressure so as to enhance the intensity of terminal plate 160, thereby allowing terminal plate 160 to be prevented from being deformed. Further, the coupling area of spinning part 130a and terminal plate 160 may be wider because electrode terminal 130 may receive relatively strong spinning pressure in the intensity of a part where reinforcing part 160a is formed on terminal plate 160. Accordingly, the contacting force exerted between insulation plate 150 and cap plate 140 may be increased. The contacting force between terminal plate 160 and electrode terminal 130 is also increased. Further, by formation of reinforcing part 160a, the contact area of electrode terminal 130 and terminal plate 160 is increased, thereby allowing electrical character to be enhanced by the resistance reduction between terminal plate 160 and electrode terminal 130, and thus reliability of can type lithium secondary battery 100 to be improved. A third groove 152 is formed on the lower surface of insulation plate 150, and third groove 152 is formed to receive the whole terminal plate 160 and is slightly bigger than terminal plate 160. A fourth groove 150c is formed in the lower surface of insulating plate 150, fourth groove 150c receives second protrusion 160b for preventing a relative rotation between insulation plate 150 and terminal plate 160 due to the spinning pressure.

FIG. 6 is a vertical cross-section view illustrating section corresponding to a cap assembly of FIG. 4 according to another exemplary embodiment of the present invention.

Referring to FIG. 6, can type lithium secondary battery 100 according to another embodiment of the present invention is almost same as that of FIGS. 1 to 4 except cap assembly 220. Accordingly, the detailed explanation of the whole structure of can type lithium secondary battery 100 will not be repeated.

Cap assembly 220 includes an electrode terminal 230 including a spinning part 230a and an edge 230b, a gasket 246, a cap plate 240, an insulation plate 250, and a terminal plate 260. Here, terminal plate 260 may include a reinforcing part 260a for preventing cap assembly 220 including terminal plate 260 from being deformed by the spinning pressure when electrode terminal 230 is inserted.

Reinforcing part 260a may be formed on the lower surface of terminal plate 260, so as to surround the peripheral part of a third terminal hole 261 of terminal plate 260. The shape of periphery of a horizontal cross section of reinforcing part 260a, may be formed in one of a circle and a square shape, just like the embodiments as shown in FIGS. 1 to 5b, but not limited thereto. Reinforcing part 260a may be formed by thickness of approximately 0.1 mm to 0.4 mm. This thickness is to consider the spinning pressure during the spinning process and the periphery of the can type lithium secondary battery. If thickness t2′ of reinforcing part 260a is below 0.1 mm, the deformation of terminal plate 260 according to the spinning pressure may not be sufficiently prevented. On the other hand, if thickness t2′ of reinforcing part 160a is above 0.4 mm, it is not suitable with the recent light weighting trend of can type lithium secondary battery 100. Further, width w2′ of reinforcing part 260a may be formed to be wider than width w1′ of edge 230b of electrode terminal 230 formed by the spinning pressure within the size range of terminal plate 260. Accordingly, reinforcing part 260a is formed so as to stably support spinning part 230a and edge 230b of electrode terminal 230, thereby preventing terminal plate 260 from being deformed by the spinning pressure. Thickness t2′ and width w2′ of reinforcing part 260a may be varied according to the structure of the lithium secondary battery.

According to another exemplary embodiment of the present invention, it is not necessary to change the shape of insulation plate 250 and cap plate 240, because reinforcing part 260a is formed on the lower surface of terminal plate 260. Therefore, reinforcing part 260a of insulation plate 250 and cap plate 240 according to another exemplary embodiment of the present invention may be formed with the plain shape shown, which is differently from reinforcing part 160a of one embodiment of the present invention.

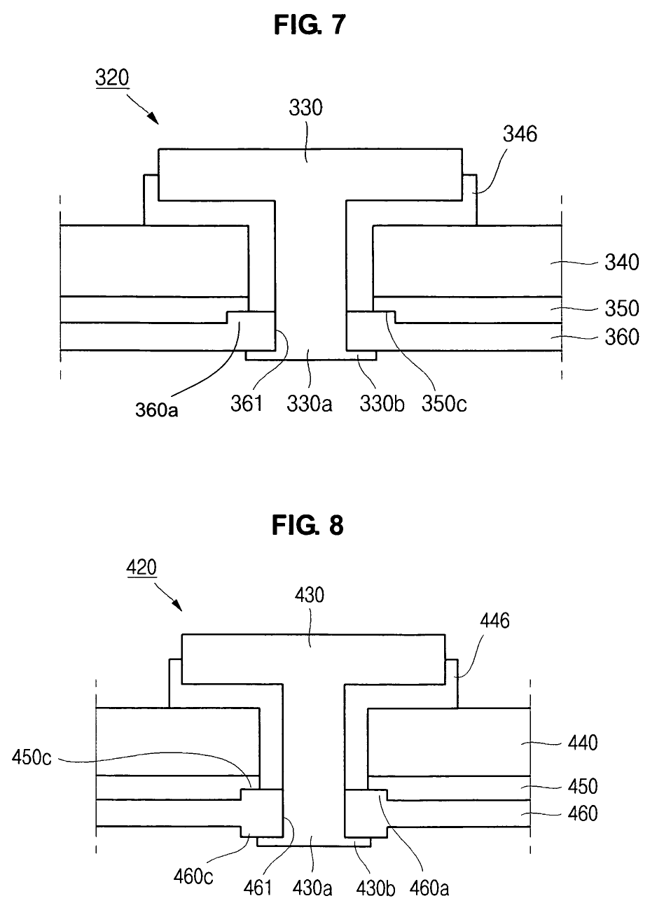

FIG. 7 is a vertical cross-section view illustrating section corresponding to a cap assembly of FIG. 4 according to still another exemplary embodiment of the present invention.

Referring to FIG. 7, can type lithium secondary battery 100 according to still another embodiment of the present invention is the same as that of FIGS. 1 to 4 except cap assembly 320. Accordingly, detailed explanation of the whole structure of can type lithium secondary battery 100 will not be repeated.

Cap assembly 320 includes an electrode terminal 330 including a spinning part 330a and an edge part 330b, a gasket 346, a cap plate 340, an insulation plate 350, and a terminal plate 360. Here, terminal plate 360 may include a reinforcing part 360a for preventing of cap assembly 320 including terminal plate 360 from being deformed by the spinning pressure when electrode terminal 330 is inserted.

Reinforcing part 360a may be formed on the upper surface of terminal plate 360 so as to surround the peripheral part of a third terminal hole 361 of terminal plate 360.

Hereafter, reinforcing part 360a may have same shape as one embodiment of the present invention.

Reinforcing part 360a may be formed on the lower surface of terminal plate 360, so as to surround the peripheral part of a third terminal hole 361 of terminal plate 360. The shape of peripheral part of a horizontal cross section of reinforcing part 360a, may be formed in one of a circle and a square shape, just like the embodiments as shown in FIGS. 1 to 5b, but not limited thereto. Reinforcing part 360a may be formed by thickness of approximately 0.1 mm to 0.4 mm. This thickness is to consider the spinning pressure during the spinning process and the periphery of the can type lithium secondary battery.

Insulation plate 350 is not formed so as to be protruded, and may include a reinforcing part groove 350c that can receive a reinforcing part 360a by being pressurized from the lower surface of insulation plate 350 towards the upper surface thereof Here, the upper surface of insulation plate 350 is formed in a flat plate shape. Groove 350c of insulation plate 350 may be formed with an appropriate depth in order that insulation plate 350 may be closely attached to terminal plate 360 by receiving reinforcing part 360a during the assembly of cap assembly 320.

FIG. 8 is a partial vertical cross-section view illustrating section corresponding to a cap assembly of FIG. 4 according to yet still another exemplary embodiment of the present invention.

Referring to FIG. 8, the can type lithium secondary battery constructed according to still another embodiment of the present invention, and is substantially the same as that of FIGS. 1 to 4 except the cap assembly 420. Accordingly, an additional detailed explanation of the whole structure of can type lithium secondary battery 100 will not be repeated.

Cap assembly 420 includes an electrode terminal 430 including a spinning part 430a and an edge part 430b, a gasket 446, a cap plate 440, an insulation plate 450 and a terminal plate 430. Here, terminal plate 460 may include reinforcing parts 460a, 460c for preventing cap assembly 420 including terminal plate 460 from being deformed by the spinning pressure when electrode terminal 430 is inserted.

Terminal plate 460 may include a first reinforcing part 460a and a second reinforcing part 460c that are formed on the upper surface thereof and the lower surface thereof respectively. First reinforcing part 460a and second reinforcing part 460c may be simultaneously formed so as to respectively surround the peripheral part of a third terminal hole 461 of terminal plate 460. The peripheral shape of a horizontal cross-section of first reinforcing part 460a and second reinforcing part 460c may be formed in one of a circle shape and a square shape, but not limited thereto. First reinforcing part 460a and second reinforcing part 460c may be formed by thickness of approximately 0.1 to 0.2 mm. This thickness is to consider the spinning pressure and the periphery of the can type lithium secondary battery. If the thickness of first reinforcing part 460a and second reinforcing part 460c is respectively below 0.1 mm, the deformation of terminal plate 260 according to the spinning pressure may not be sufficiently prevented. On the other hand, if the thickness of first reinforcing part 460a and second reinforcing part 460c is respectively above 0.2 mm, it is not suitable with the recent light weighting trend of the can type lithium secondary battery. Further, the width of first reinforcing part 460a and second reinforcing part 460c may be formed to be wider than that of edge 430b of electrode terminal 430 formed by the spinning pressure within the size range of terminal plate 460. Accordingly, first reinforcing part 460a and second reinforcing part 460c may be formed so as to stably support spinning part 430a and edge 430b of the electrode terminal 430. Terminal plate 460 is increased the intensity thereof by forming first reinforcing part 460a and second reinforcing part 460c, thereby preventing from being deformed by relatively high spinning pressure.

Insulation plate 450, same as insulation plate 350 constructed according to still another exemplary embodiment of the present invention, may include groove 450c that can receive first reinforcing part 460a by being pressurized toward the lower surface into the upper surface, but not limited thereto.

Further, same as one embodiment stated above, insulation plate 450 may include a protrusion (not shown in figures) protruded toward the cap plate 440 so as to receive first reinforcing part 460a and a groove (not shown in figures) formed on cap plate 440 for receiving the protrusion.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A can type lithium secondary battery, comprising:
an electrode assembly comprising a first electrode plate, a second electrode plate and a separator;
a can receiving the electrode assembly and an electrolyte; and
a cap assembly comprising a cap plate, an insulation plate, a terminal plate, an electrode terminal, and a gasket so oriented as to be coupled to an upper end opening of the can, with the terminal plate comprising a reinforcing part formed to surround a peripheral part of a terminal hole where the electrode terminal is inserted.

2. The can type lithium secondary battery of claim 1, wherein the reinforcing part is formed on one of an upper surface and a lower surface of the terminal plate.

3. The can type lithium secondary battery of claim 1, wherein a periphery of a horizontal section of the reinforcing part is formed with one of a circular shape and a square shape.

4. The can type lithium secondary battery of claim 2, wherein the reinforcing part is formed with thickness of approximately 0.1 mm to 0.4 mm.

5. The can type lithium secondary battery of claim 2, wherein the electrode terminal comprises a spinning part being formed on a lower part of the terminal plate and comprising an edge protruding away from a center axis of the electrode terminal, and wherein the reinforcing part is formed to be wider than the edge part.

6. The can type lithium secondary battery of claim 4, in which
the insulation plate, when the reinforcing part is formed on the upper surface of the terminal plate, comprises a first protrusion protruded toward the cap plate as much as thickness corresponding to thickness of the reinforcing part, and a fifth groove for receiving the reinforcing part; and
the cap plate comprises a first groove for receiving the first protrusion.

7. The can type lithium secondary battery of claim 1, wherein the reinforcing part comprises a first reinforcing part and a second reinforcing part respectively formed on the upper and lower surfaces of the terminal plate.

8. The can type lithium secondary battery of claim 7, wherein the first reinforcing part and the second reinforcing part are formed with thickness of approximately 0.1 mm to 0.2 mm.

9. The can type lithium secondary battery of claim 1, wherein the reinforcing part is integrated together with the terminal plate as a monolithic structure.

10. The can type lithium secondary battery of claim 1, wherein the insulation plate further comprises a first protrusion preventing a relative rotation between the cap plate and the insulation plate when the electrode terminal is inserted through terminal holes.

11. The can type lithium secondary battery of claim 10, wherein the first protrusion of the insulation plate is received by the first groove formed in lower surface of the cap plate, and the terminal plate further comprises a second protrusion preventing a relative rotation between the insulation plate and the terminal plate, when the electrode terminal is inserted through the terminal holes.

12. The can type lithium secondary battery of claim 1, wherein the cap plate comprises a second groove receiving a third protrusion for preventing a relative rotation between the cap plate and the insulation plate.

13. A can type lithium secondary battery, comprising:
an electrode assembly comprising a first electrode plate, a second electrode plate and a separator formed between the first electrode plate and the second electrode plate;
a can receiving the electrode assembly and an electrolyte;
a cap assembly coupled to an upper end opening of the can;
the cap assembly comprising a cap plate having a first terminal hole, an insulation plate having a second terminal hole, a terminal plate having a third terminal hole, an electrode terminal inserted through the first, second and third terminal holes by a spinning process, a gasket insulating the electrode terminal from cap plate, and said insulation plate insulating the cap plate from the terminal plate;
a reinforcing part, formed on a peripheral part of the third terminal hole, preventing the cap assembly including the terminal plate from being deformed by a spinning pressure of an electrode terminal; and
the reinforcing part formed, in predetermined shape, width and thickness, to surround a peripheral part of the third terminal hole.

14. The can type lithium secondary battery of claim 13,
with the reinforcing part formed with thickness of approximately 0.1 mm to 0.4 mm, when the reinforcing part is formed on one of an upper surface and a lower surface of the terminal plate; and
with the reinforcing part being formed with thickness of approximately 0.1 mm to 0.2 mm, when the reinforcing part comprises a first reinforcing part and a second reinforcing part respectively formed on the upper and lower surfaces of the terminal plate.

15. The can type lithium secondary battery of claim 13, with a circumstance of a horizontal cross-section of the reinforcing part formed in one of a circle shape and a square shape.

16. The can type lithium secondary battery of claim 13, with the electrode terminal further comprising a head, a spinning part where the spinning process applied and an edge with a width smaller than the width of said reinforcing part.

17. The can type lithium secondary battery of claim 14, with the cap plate further comprising a first groove for receiving a first protrusion formed in the upper surface of the insulation plate, and the first protrusion protruding toward the cap plate as much as a thickness of the reinforcing part, when the reinforcing part is formed on the upper surface of the terminal plate.

18. The can type lithium secondary battery of claim 13, further comprising:
a third protrusion formed on an upper surface of the insulating plate and a second groove formed in a lower surface of the cap plate, said second groove receiving said third protrusion for preventing a relative rotation between said insulation plate and said cap plate due to the spinning pressure;
a second protrusion formed on an upper surface of the terminal plate and a fourth groove formed in a lower surface of the insulating plate, said fourth groove receiving said second protrusion for preventing a relative rotation between said insulation plate and said terminal plate due to the spinning pressure; and
a third groove formed in a lower surface of the insulation plate for receiving the terminal plate.
